(19) United States
(12) Patent Application Publication
(10) Pub. No.: US 2009/0092714 A1
(43) Pub. Date: Apr. 9, 2009

(54) COAXIAL MULTI-COMPONENT ROASTABLE FOOD ITEM

(76) Inventor: Edward F. SPELLMAN, Lakewood, OH (US)

Correspondence Address: D.A. STAUFFER PATENT SERVICES LLC, 1006 MONTFORD ROAD, CLEVLAND HTS., OH, 44121-2016, US

(21) Appl. No.: 12/247,056

(22) Filed: Oct. 7, 2008

Related U.S. Application Data
(60) Provisional application No. 60/998,137, filed on Oct. 9, 2007.
(60) Provisional application No. 60/999,161, filed on Oct. 16, 2007.

(51) Int. Cl. A23G 3/56; A23G 3/54

(52) U.S. Cl. 426/90; 426/89; 426/103; 426/303

(57) ABSTRACT

A multi-component food item and method of fabricating it to be roastable. A first food component is formed and processed to make a core that is a substantially rigid support structure having a center axis; and a different food component is coaxially coated on a coatable portion of the core to make a first of one or more food layers. Preferably a holding feature is provided to make the item roastable. An uncoated portion of the core can be used as a holding peg designed to removably engage with an externally gripping tip of an elongated roaster. A substantially axial bore hole in the core can be used to removably engage with a press-fitted internally gripping tip of a roaster. Preferably at least the outwardly exposed one of the one or more coaxial food layers is roastable in that it is improved in some palatable manner by roasting.

### CROSS-REFERENCE TO RELATED APPLICATIONS

This application claims the benefit of U.S. Provisional Patent Application No. 60/998,137 filed Oct. 9, 2007 by E. F. Spellman, and of U.S. Provisional Patent Application No. 60/999,161 filed Oct. 16, 2007 by E. F. Spellman; both applications hereby being incorporated in their entirety by reference herein.

### TECHNICAL FIELD OF THE INVENTION

The present invention relates to a pre-assembled multi-component edible food item and, more particularly to an assembly suitable for roasting on a stick.

### BACKGROUND OF THE INVENTION

S'mores are a treat usually enjoyed while sitting around a campfire or standing around a barbecue. They are created by sandwiching a hot, just-roasted (or “toasted”) marshmallow and a flat piece of chocolate between two graham crackers. Heat from the roasted marshmallow is supposed to melt the chocolate and form a gooey filling that when combined with graham crackers is both tasty to consume and fun to make.

There are several drawbacks to traditional s'mores. Often the person making and consuming the s'mores, usually a child, will get messy when the melted chocolate and roasted marshmallow ooze out of the graham cracker sandwich. Then there is the hassle and expense of trying to have the correct amount of each component on hand when needed. Inevitably, some of the components get wasted and discarded. Another problem comes in trying to keep the marshmallow on the roasting implement (e.g., pointed stick). As the marshmallow heats up it suddenly changes to goo which can easily fall off of the implement. And last, but certainly not least, there is the safety concern of having a child, or more often, children roasting marshmallows around a fire or hot barbecue using sharp pointed sticks, skewers, forks and the like. Such a scene is practically begging for a trip to the nearest emergency room.

Two examples of prior art attempts to address the messiness issues are found in U.S. Pat. No. 6,800,312 (Biggs; Oct. 5, 2004) and Patent Application Publication US 2006/0193,967 (Tucker; Aug. 31, 2006). Biggs discloses a marshmallow system and s'more making method to solve the problem of melted chocolate dripping from the crackers after assembling the s'more. Biggs' marshmallow system includes a marshmallow having a bore hole defined therein and a chocolate portion configured for being received within the bore hole, wherein the chocolate may be positioned within the bore hole and the thus prepared marshmallow/chocolate portion exposed to heat to toast the marshmallow and substantially melt the chocolate portion. The toasted marshmallow with chocolate may be eaten as is, or made into a s'more by pressing it between graham crackers. Biggs states that the open end of the bore hole tends to close to substantially retain the melted chocolate within the bore hole. The shape of the chocolate doesn't matter, but is preferred to be like milk chocolate in that it is substantially hardened at room temperature, yet will melt and flow when heated. He gives two examples of suitable chocolate portions: pieces of Tootsie Roll™ or Hershey's™ Chocolate Bar. Biggs is silent on how to hold his marshmallow system for toasting (roasting).

Tucker discloses a marshmallow containing a soft textured chocolate center. She states that when roasted, the chocolate inside the marshmallow becomes slightly melted and is soft, so that when it is used in the making of s'mores, it allows for a more convenient, a smoother-textured, and a more enjoyable s'more. She further states: “As a child, I personally would insert a piece of a chocolate bar into the marshmallow before roasting. This was not convenient as it made a sticky mess, because the chocolate was hard to begin with it never melted through. And because of the large hole it left in the marshmallow, the marshmallow and chocolate often ended up falling off the stick and into the fire. Through trial and error I have created the invention described . . . that achieves the effect I wanted. The chocolate is melted with the marshmallow, and of a soft consistency, making the taste and texture smooth, slightly melted when roasted, and more enjoyable. The sticky mess is reduced and it goes easily on and off of a roasting stick.” She also mentions that the marshmallow with soft textured chocolate center can be eaten on its own, with or without roasting or graham crackers. With regards to holding the marshmallow/soft-chocolate combination for roasting, she goes on to state that the chocolate is of a consistency that allows a roasting stick to be easily inserted for roasting, however it is firm enough that the majority of the chocolate will remain in the marshmallow and not leak out.

Addressing some other issues, U.S. Pat. No. 6,296,884 (Okerlund; Oct. 2, 2001) discloses a pre-packaged s'more kit containing a plurality of marshmallows, crackers, and flavored wafers shaped to fit inside an elongated container. Preferably, the kit includes a roasting utensil also designed to fit within the elongated container. Advantageously, a s'more connoisseur need only purchase one easily storable and transportable kit instead of separately purchasing the ingredients in bulk (because suitably matched quantities are included in the kit). The kit includes a “safer roasting utensil with generally rounded features also designed to fit within the elongated container . . . . Referring to [Okerlund's] FIG. 3, a preferred embodiment includes a roasting utensil (20) allowing a user to safely suspend at least one marshmallow over a heat source such as a fire or hot coals. Roasting utensil includes an elongated handle (22) with a roasting tip (24) securely fastened to one end. In one version, the roasting tip (24) includes a base (26), first and second supports (28, 30), and a holder (32) configured to receive and hold at least one marshmallow.” Viewing Okerlund's FIG. 3, the roasting tip appears to be wire formed into a U-shaped center portion sized to grip the circumference of the marshmallow.

None of these prior art examples, alone or in combination, provide a complete and satisfactory solution to the combined problem of safely, and without significant mess, roasting a marshmallow, melting chocolate, and combining both with a graham cracker substrate for easy consumption, especially by younger persons. Thus it is an object of the present invention to overcome these problems and provide said satisfactory solution.

### BRIEF SUMMARY OF THE INVENTION

Some general characteristics of the invention are as follows:

Generally it's a multi-component food item built on a relatively rigid core that is adapted for placement on a holding stick (“roaster”) for roasting/heating/cooking.

A preferred embodiment is an inside-out “s'more” having a graham cracker core, sheathed by a chocolate coating or layer, and then a marshmallow coating (layer).

Core can be solid, but is preferably hollow/tubular defining an axis of revolution for turning the item while roasting it over a fire (heat source).

Hollow core preferably has soft food item overlapping and/or within the hollow (cavity) for holding the point of a stick placed therein (e.g., marshmallow covers core opening).

A resilient, heat resistant, food-safe roaster tip may be made available in a size that friction-fits over an extended portion of the core or into the hollow, and/or the hollow may be made with a socket shape that particularly suits such a special tip.

A compartmented tray is preferably supplied wherein each compartment holds a single item with the extended portion or the hollow facing upward as appropriate for easy engagement with a suitable roasting stick, preferably one having the special tip.

According to the invention a coaxial multi-component roastable food item is disclosed, wherein the term roastable refers to an item that is beneficially affected by exposure to a heat source, and/or that has a structure that facilitates roasting of the item, the food item comprising: a structural core having a center axis and a coatable portion; and one or more food layers that are coaxially coated about the coatable portion of the core; wherein: the core comprises a first food component that is formed into a shape having a central axis, and is processed such that it is sufficiently stiff and strong to be a structure for supporting all food components that are to be assembled with it; and at least one of the one or more food layers comprises a second food component, different than the first food component.

According to the invention the inventive food item further comprises a first food layer that is coaxially coated about the coatable portion of the core; and a second food layer that is coaxially coated about the first food layer; wherein: the first food layer comprises a second food component, different than the first food component; and the second food layer comprises a third food component, different from the first and second food components. In one embodiment, the core comprises graham cracker; the first layer comprises chocolate; and the second layer comprises marshmallow; thereby forming an inside-out “s'more”.

According to the invention, the inventive food item is characterized in that an outwardly exposed one of the one or more food layers is roastable.

According to the invention, the inventive food item is characterized in that the core is substantially rotationally symmetric about the center axis; the one or more food layers are only coated about the coatable portion of the core, and the coatable portion is less than an axial length of the core; and an uncoated portion of the core comprises a holding feature that can be removably engaged with a holding tip of a roaster, thereby facilitating roasting of the food item. Optionally the uncoated portion of the core is formed into a relatively short, generally cylindrical holding peg shape designed to removably engage with a mating externally gripping roaster tip.

According to the invention the inventive food item further comprises a substantially axial bore hole that hollows out at least a portion of an axial length of the core and opens out through an axial end of the core.

According to the invention the inventive food item further comprises a filling comprising a filling food component, different than the first food component of the core, assembled as a filling in the bore hole; and wherein a food layer extends over, and covers, the axial end of the core through which the bore hole opens.

According to the invention, the inventive food item is characterized in that the bore hole is fabricated with an inside wall shape and size designed to removably engage, by press fitting, with a mating elongated internally gripping roaster tip that is laterally compressible, and that has an uncompressed size slightly bigger and/or differently shaped than the bore hole's inside size and/or wall shape; thereby facilitating roasting of the food item. Preferably the bore hole funnels to a minimum diameter then opens back up thereafter, thereby facilitating removable engagement with a roaster tip that has a domed tip with a relief split therein and a dome uncompressed diameter slightly greater than the bore hole minimum diameter.

According to the invention the inventive food item further comprises a flange-like shoulder portion of the core located at an axial end of the coatable portion of the core, and having a lateral dimension greater than that of the coatable portion.

According to the invention, a method of fabricating a multi-component food item such that it is roastable is disclosed, the method comprising the steps of: using a first food component to fabricate a substantially rigid support structure as a core; forming the core in a substantially rotationally symmetric shape about a center axis; and using a different food component for coaxially coating one or more food layers on a coatable portion of the core. Preferably the method further comprises the step of using a roastable food component for an outwardly exposed one of the one or more food layers. Optionally the method further comprises the step of coating the one or more food layers only about the coatable portion of the core; and leaving an uncoated portion of the core exposed for use as a holding feature that can be removably engaged with a holding tip of a roaster.

According to the invention, the method further comprises the step of forming the uncoated portion of the core into a relatively short, generally cylindrical holding peg shape designed to removably engage with a mating externally gripping roaster tip.

According to the invention, the method further comprises the step of forming a substantially axial bore hole that hollows out at least a portion of an axial length of the core and opens out through an axial end of the core. An additional step may comprise covering the bore hole opening by extending a coaxially coated food layer over an axial end of the core.

According to the invention, the method further comprises the step of fabricating the bore hole with an inside wall shape and size designed to removably engage, by press fitting, with a mating elongated internally gripping roaster tip that is laterally compressible, and that has an uncompressed size slightly bigger and/or differently shaped than the bore hole's inside size and/or wall shape. Further steps may comprise fabricating the bore hole with an inside wall shape that funnels to a minimum diameter then opens back up thereafter; and providing a roaster tip that has a domed tip with a relief split therein and a dome uncompressed diameter slightly greater than the bore hole minimum diameter.

According to the invention, the method further comprises the step of fabricating a flange-like shoulder portion of the core located at an axial end of the coatable portion of the core, and having a lateral dimension greater than that of the coatable portion.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a side view of an “inside-out s'more” embodiment of a coaxial multi-component roastable food item, showing a core of a graham cracker component extending upward from a coaxial layer of a marshmallow component, according to the invention.

FIG. 2 is a top view of the coaxial multi-component roastable food item embodiment of FIG. 1, according to the invention.

FIG. 3 is a bottom view of the coaxial multi-component roastable food item embodiment of FIG. 1, according to the invention.

FIG. 4 is a top and side perspective view of the coaxial multi-component roastable food item embodiment of FIG. 1, according to the invention.

FIG. 5 is a bottom and side perspective view of the coaxial multi-component roastable food item embodiment of FIG. 1, according to the invention.

FIG. 6 is a bottom and side perspective view of the graham cracker core of the coaxial multi-component roastable food item embodiment of FIG. 1, showing a holding peg portion, a shoulder portion, and a coatable portion with a bore hole, according to the invention.

FIG. 7 is a bottom and side perspective view of the graham cracker core showing the coatable portion (ghosted) covered by a first coaxial layer (chocolate in this embodiment), according to the invention.

FIG. 8 is a bottom and side perspective view of the graham cracker core showing the chocolate layer (ghosted) covered by a second coaxial layer (marshmallow in this embodiment), according to the invention.

FIG. 9 is a top and side perspective view of the coaxial multi-component roastable food item embodiment of FIG. 1 being held on a roasting stick by an external gripping tip, according to the invention.

FIG. 10 is a bottom and side perspective view of the coaxial multi-component roastable food item embodiment of FIG. 1, showing the marshmallow layer being pierced by and supported on a sharpened stick according to the invention.

FIG. 11 is a perspective view of a storage tray with twenty-four of the coaxial multi-component roastable food item embodiments of FIG. 1 protectively stored therein, according to the invention.

FIG. 12 is a cross-sectional side view, taken along an axially aligned plane, of the coaxial multi-component roastable food item in the embodiment of an inside-out s'more, the view showing the core with a top portion of the bore hole that is a cylindrical extension of a tapered portion of the bore hole, according to the invention.

FIG. 13 is a cross-sectional side view, taken along an axially aligned plane, of the coaxial multi-component roastable food item showing a solid core, according to the invention.

FIG. 14 is a cross-sectional side view, taken along an axially aligned plane, of the coaxial multi-component roastable food item showing a filling food component in the bore hole, according to the invention.

FIG. 15 is a cross-sectional side view, taken along an axially aligned plane, of the coaxial multi-component roastable food item showing the coatable portion of the core extending through the second coaxial layer such that the bore opens outward, according to the invention.

FIG. 16 is a cross-sectional side view, taken along an axially aligned plane, of the coaxial multi-component roastable food item showing the core with a bore hole and a shoulder portion but no holding peg portion, according to the invention.

FIG. 17 is a cross-sectional side view, taken along an axially aligned plane, of the coaxial multi-component roastable food item showing the core with a cylindrical bore hole, no holding peg portion, a shoulder portion at both top and bottom ends, and a hexagonal counter bore at both ends of the bore hole, according to the invention.

FIG. 18 is a top view of the coaxial multi-component roastable food item of FIG. 17, according to the invention.

FIG. 19 is a cross-sectional side view, taken along an axially aligned plane, of the coaxial multi-component roastable food item showing the core with a cylindrical bore hole, no holding peg portion, and no shoulder portions, according to the invention.

FIG. 20 is a top and side perspective view of the coaxial multi-component roastable food item showing the holding peg portion of the core having a bore hole (top portion visible) and a hexagonal counter bore, according to the invention.

FIG. 21 is a side view of the coaxial multi-component roastable food item embodiment of FIG. 20, according to the invention.

FIG. 22 is a cross-sectional side view, taken along an axially aligned plane, of the core of the coaxial multi-component roastable food item embodiment of FIG. 20, according to the invention.

FIG. 23 is a side view of an internally gripping tip on a rod member to form a custom roasting stick, according to the invention.

FIG. 24 is a side view of the internally gripping tip of FIG. 23 removably engaged within the core of FIG. 22 (viewed in cross-section), according to the invention.

FIG. 25 is a top and side perspective view of the coaxial multi-component roastable food item embodiment of FIG. 20 with the internally gripping tip of FIG. 23 removably engaged therewithin, according to the invention.

### DETAILED DESCRIPTION OF THE INVENTION

The present invention, concerns, in general, a coaxial multi-component roastable food item (inventive “food item” for short) that is a preassembled/prefabricated food item (i.e., humanly edible) having a plurality of food components assembled around and along a common axis, i.e. coaxial. Food components are defined as complete food items; therefore a single food component can have many ingredients that have been prepared as needed to make an edible food item. For example, a food component may be a graham cracker comprising graham flour and other ingredients mixed together, shaped and baked to a “cracker”-like consistency that is ready to eat as a “graham cracker” (albeit potentially in a unique shape other than a flat wafer).

The inventive food item is particularly characterized as being “roastable”, meaning that it is not harmed by, and is preferably beneficially affected by, exposure to a radiant (and typically also convective) heat source, such that the food item is improved in some palatable manner by roasting (a.k.a. toasting). Therefore the inventive roastable food item is intended to be roasted before (human) consumption in order to be most palatable, but the intended roasting is not necessarily required to make the food item safely edible. In fact, most of the presently contemplated varieties of the coaxial multi-component roastable food item are safely and palatably edible as provided, without roasting or heating in any way. Thus, the inventive food item comprises an assembly of food components that is safe and generally appealing for human consumption “out of the box” as purchased, but is designed to be conveniently roasted as a way to potentially enhance its palatability (i.e., taste, texture, consistency, aroma, appearance, and the like). A preferred additional design objective is to provide a structure for the roastable food item such that the food item is convenient and safe to roast, preferably over an open fire. In general, roasting is a method of heating or cooking food by placing the food item in close proximity to an intense heat source, e.g. flame, hot coals, electric burner, etc.

A representative example of the present invention will be described hereinbelow using a preferred embodiment characterized as an “inside-out s'more”. Even though the discussion to follow focuses on the inside-out s'more embodiment, the invention encompasses any coaxial multi-component roastable food item, as defined and limited in the claims, considered in light of the description and drawings.

An inside-out s'more is a food “treat” that combines the components of a traditional “s'more”, namely marshmallow, chocolate, and graham cracker, into one preassembled coaxial confection that has the components arranged in reverse order of a traditional s'more. Instead of having a roasted marshmallow placed between two graham cracker wafers, the present invention has a graham cracker core and a marshmallow for roasting that is preassembled on the outside. Between these two components, in both the traditional s'more and the present invention, is a layer of chocolate. A significant advantage of the “inside-out” construction is that the entire confection can be preassembled and sold as a unit because the component that is typically roasted, the marshmallow, is on the outside ready to be roasted before the confection is eaten. In prior art s'mores the three components are purchased separately, and the marshmallow component must be roasted separately, then assembled (while hot and gooey) with the other two components before the assembly can be eaten.

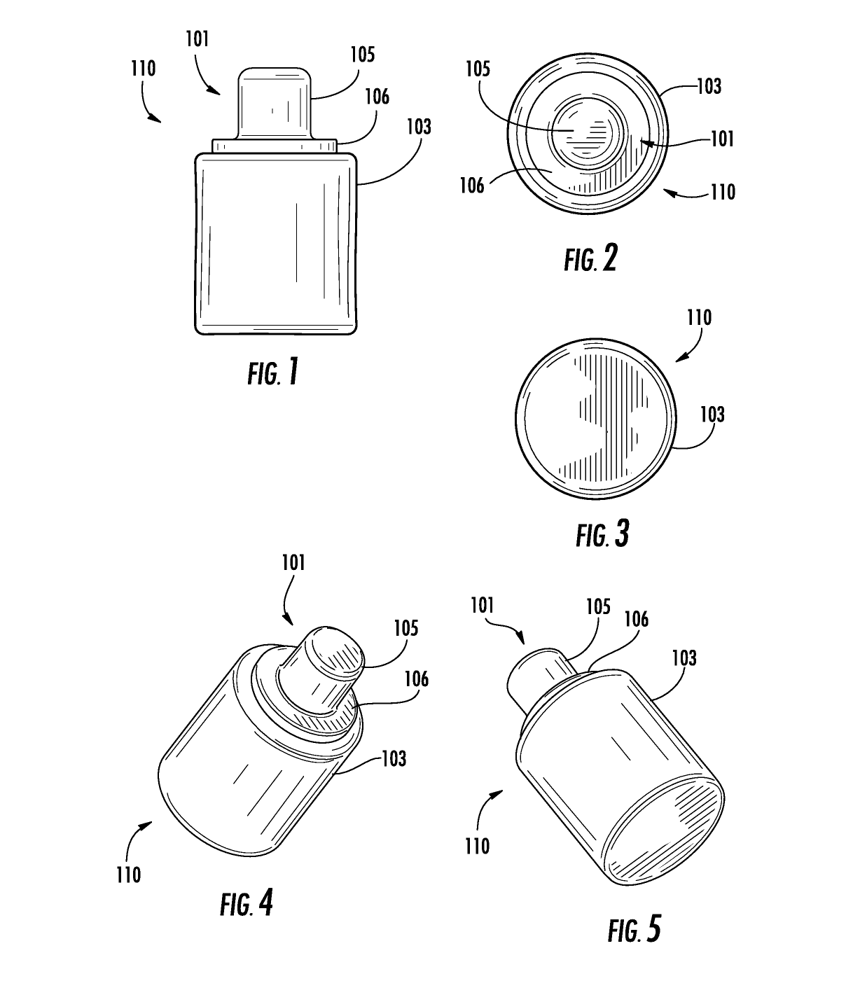

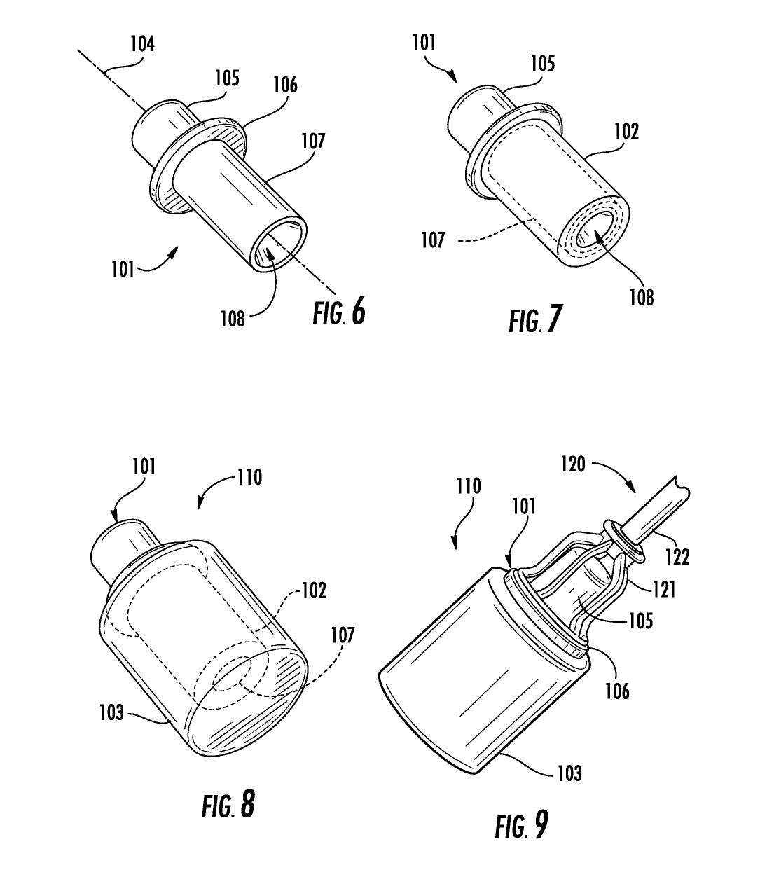

FIGS. 1-11 show a first version of the inside-out s'more embodiment of the inventive coaxial multi-component roastable food item 110; while variations on the theme are illustrated in the remaining Figures showing some of the many possible versions of the inventive coaxial multi-component roastable food item 110 as implemented for an inside-out s'more embodiment thereof.

Although the invention is not limited to a particular size, it should be understood that practicality and suitability for roasting and/or eating will generally influence size and relative dimensions. For example, the exemplary inside-out s'more embodiment 110 is most likely to be provided in a size/shape similar to a common marshmallow. Thus, a marshmallow outer layer 103 may be a standard 1⅛″ (inch) diameter by 1¼″ high marshmallow, and a holding peg 105 may be sized in relation to that, e.g., ½″ diameter×½″ high.

FIGS. 1-5 comprise various views of an embodiment of the inside-out s'more 110, illustrating a graham cracker core 101, and an outwardly exposed marshmallow layer 103 that encases all but an axially projecting holding peg portion 105 and a shoulder portion 106, the latter two elements being portions of the core 101 (described further hereinbelow).

FIGS. 6-8 illustrate steps of an inventive fabrication/assembly process (method) as applied for the exemplary inside-out s'more 110.

FIG. 6 shows the graham cracker core 101 of the coaxial multi-component roastable food item embodiment 110 of FIGS. 1-5. Fabrication of the core 101 is a first step of the exemplary fabrication method. In general, the core 101 is a first food component fabricated such that it will serve as a structural support for one or more food component layers and/or fillings that are to be assembled on it. “Graham cracker” is an example of a food component that can be formed into a desired core shape (e.g., as shown for the core 101 in FIG. 6) and can be processed such that it is sufficiently stiff and strong to be the supporting structure for the completed food item 110. As a supporting structure, the core 101 must be able to maintain the physical integrity of the item 110 under normally anticipated conditions of handling, and eating. Preferably the core 101 also provides support that is sufficient to facilitate roasting by maintaining the physical integrity of the item 110 under normally anticipated conditions of roasting, thereby making the food item 110 “roastable”. For example, the ingredients of a graham cracker core 101 are combined and mixed to form a flexible dough which is then shaped (e.g., in a mold) as desired and then cooked (baked) to form a substantially rigid cracker in the desired core shape. Optionally additional shaping processes may be employed besides molding, e.g., boring, grinding, sanding, scraping, carving, and the like.

Referring to FIG. 6, the illustrated embodiment of the core 101 is a substantially rigid structure having a center axis 104, and comprising a generally cylindrical coatable portion 107, a flange-like shoulder portion 106 at an axial end of the coatable portion 107, and generally cylindrical but having a second diameter greater than the diameter of the coatable portion 107, a generally cylindrical holding peg portion 105, relatively short compared to an axial length of the coatable portion 107, and an axial bore hole 108. Preferably, but not necessarily, the core 101 is substantially rotationally symmetric about the center axis 104, as shown. The illustrated core 101 is generally cylindrical in that it has a circular cross-section centered on the axis 104 although it doesn't have a constant diameter. Thus the term “cylindrical” as used herein is to be interpreted broadly, as in “generally cylindrical”. The term “rotationally symmetric” is used herein in a generalized sense that is intended to encompass three-dimensional objects that exhibit cross-sections taken normal to the axis that have substantially regular polygonal circumferences with a mean radius and number of vertices that can vary from one cross-section to another along the length of the axis. Thus, for example, the coatable portion 107 could be square (in cross-section), the shoulder portion 106 could be octagonal, and the holding peg portion 105 could be a three-sided pyramid or a spline or a screw thread, etc. Finally, the “rotational symmetry” is preferred and “substantially” applied. So the regular polygon can be mostly regular, i.e., somewhat irregular, and a cylinder with, for example, one flat side is also included even though it isn't perfectly symmetric. Although the bore hole 108 is shown in the drawings as a coaxially bored hole (i.e., axially aligned and centered), the disclosed bore hole 108 should be understood to encompass any hole or cavity that extends mainly in the axial direction, regardless of how it is formed (i.e., it doesn't have to be “bored” as with a drill).

It will be seen from the forgoing description that the only necessary (i.e., non-optional) portion of the core 101 is the coatable portion 107 which defines the center axis 104 and provides a substantially rigid supporting structure for the inventive food item 110. However, in order to facilitate roasting of the assembled (completed) food item 110 there is preferably a holding feature of some kind that will facilitate holding the food item 110 while it is being roasted. Therefore a holding feature is something that will removably engage with a suitable holding device, i.e., a roaster (an elongated rod member with a removably engaging holding tip). It will be seen that the holding peg portion 105 and/or the bore hole 108 serve as holding features.

FIG. 7 illustrates a second step of the exemplary fabrication method, wherein the coatable portion 107 (ghosted) of the core 101 is coaxially coated by a first layer 102 of food (chocolate in this embodiment), thereby providing one of one or more food layers (e.g., layers 102, 103) that are coaxially coated about a portion of the core 101.

FIG. 8 illustrates a third step of the exemplary fabrication method, wherein the chocolate layer 102 is covered by the marshmallow layer 103 thereby providing a second food layer 103 that is coaxially coated about the first food layer 102.

At least one of the one or more food layer(s) 102, 103 is a second food component, different than the first food component used for the core 101. In this example (a s'more) three different food components are utilized, one for each of the core 101 (graham cracker), the first layer 102 (chocolate), and the second layer 103 (marshmallow).

For convenient fabrication, one or more of the food components used for the layer(s) 102, 103 preferably can be made in a liquid or other flowable state that can be solidified into a stable layer at room temperature after it is coated about the core 101. The chocolate first layer 102 exemplifies an ideal food component for fabrication in that it can be liquefied by heating, coated by dipping the core 101 in it, and stabilized as a sheath-like coating by the solidifying that occurs as the chocolate is cooled. Of course a non-liquid form could also be used for coating the core 101 with the chocolate layer 102 just as it is most likely done for a marshmallow layer 103. For example, the chocolate first layer 102 could be pre-formed as a hollow tubular sheath that is slipped over the coatable portion 107 of the core 101, and then perhaps held in place by pressing parts of it against the core 101. Many methods will be thought of given these teachings.

Given the teachings of the present disclosure, implementation of the inventive fabrication method shouldn't be difficult, especially for companies that make cookies or snack cakes. For example, the inside-out s'more 110 can be fabricated as follows: first mold the graham cracker core 101 then bake it. Once baked, the graham cracker core 101 will have sufficient strength for subsequent operations, shipping, and holding for roasting. After the graham cracker core 101 is baked it can be dipped in heated chocolate to form the chocolate layer 102. Once the chocolate layer 102 has hardened, a marshmallow that was either formed with a cavity, or was formed and then bored to create the cavity, can be fitted onto the graham cracker core 101 plus chocolate layer 102 assembly; or for example, the marshmallow layer 103 can be formed around the assembled graham cracker core 101 and chocolate layer 102. The complete assembly of the graham cracker core 101 plus the chocolate layer 102 plus the marshmallow layer 103, i.e. an inside-out s'more 110, is an exemplary embodiment of the invention. Although chocolate and marshmallow lend themselves to different methods for coating the core 101, the present inventive food item 110 is not limited to any particular coating method for any of one or more layers (e.g., 102, 103) that may be part of the fabricated end product.

The inside-out s'more 110 embodiment also exemplifies at least one way to make the coaxial multi-component roastable food item 110 “roastable”: by using a roastable food component for the outwardly exposed food layer 103, which in this case is the marshmallow second layer 103. Marshmallow is “roastable” because it is beneficially affected by roasting, wherein the heat caramelizes the exposed surface(s), and provides an interesting combination of textures with the crispy outside and the warm gooey inside. Of course this would still be the case even if the marshmallow layer 103 were the only layer coaxially coated about a portion of the core 101, thereby making a two component coaxial multi-component roastable food item 110.

An advantage of the inventive version of a “s'more” is that the underlying chocolate layer 102 will be heated at the same time that the marshmallow layer 103 is heated, thereby making softening or melting of the chocolate more likely than when a conventional chocolate piece is heated only after the conventionally roasted marshmallow has been conventionally pressed against the chocolate between conventional crackers after the marshmallow has been heated and is now cooling off.

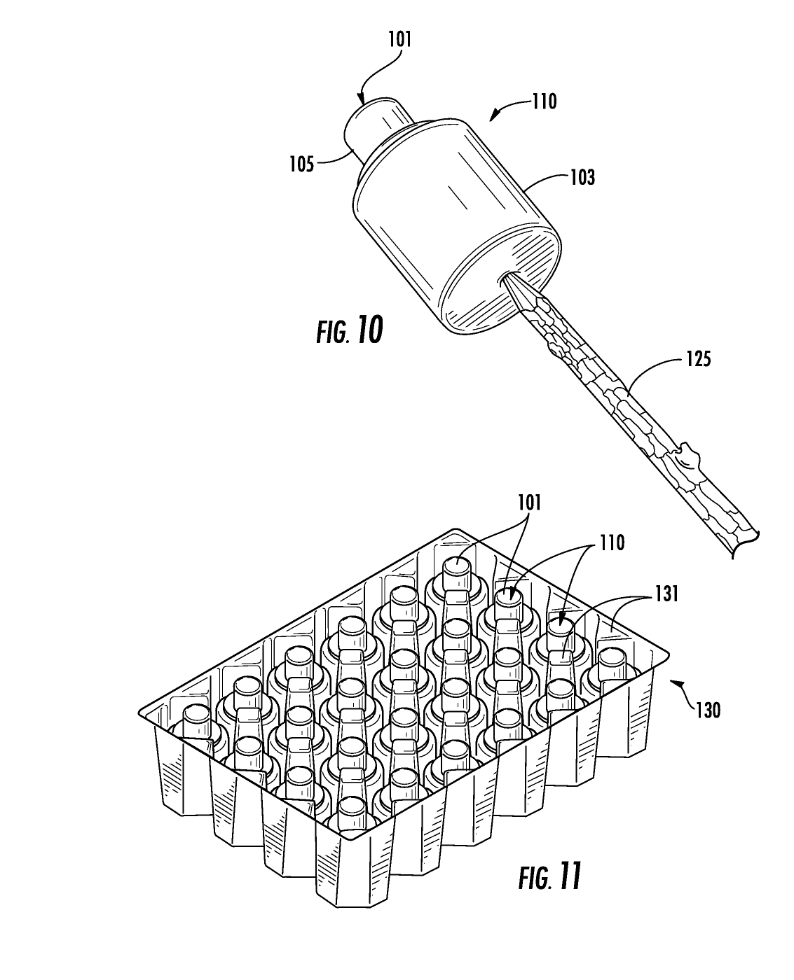

FIGS. 9 and 10 highlight another way that the inventive coaxial multi-component roastable food item 110 can be made “roastable”: by providing a structure for a roastable food item such that the food item is convenient and safe to roast, even in close proximity to an intense heat source.

FIG. 9 shows the inside-out s'more 110 of FIGS. 1-8 removably attached to (held on) a roaster 120 (roasting device) that has a cage-like external gripping tip 121 on a rod member 122. The holding peg portion 105 of the core 101 provides a convenient rigid handle-like holding feature designed to be removably engaged with a suitably mating gripper (e.g., cage tip 121) on a stick (e.g., rod 122). The external gripping tip 121 is made of a resilient, heat resistant material, e.g. silicone, and is sized such that it must stretch slightly in order for it to be engaged on the holding peg 105 of the core 101. This allows the Inside-Out S'more 110 to be installed on and removed from the roaster 120 easily. By fabricating the s'more 110 with a holding peg 105, the invention provides a food item that is roastable using a roaster 120 with a soft tip (e.g., cage tip 121)—much safer than a sharp-pointed stick.

FIG. 10 shows the inside-out s'more 110 of FIGS. 1-8 removably attached to (held on) a conventional sharpened stick 125. Although not as safe as using a soft-tipped roasting stick, nevertheless the invention still provides a food item that is roastable on a traditional stick 125 while adding some elements of safety and/or convenience. For instance, when used like this the holding peg 105 of the graham cracker core 101 can act as a handle to be hand held by a user while installing the raw inside-out s'more 110 onto, and while removing the roasted inside-out s'more 110 off of, the pointed stick 125. The holding peg 105 allows for a secure grip on the s'more 110 while it is being skewered on the stick 125, and also enables removing the s'more 110 from the stick 125 without having to touch the hot gooey marshmallow 103 after it has been roasted. Furthermore, the bore hole 108 serves as a stop and a trap for the sharp tip of the stick 125, preventing the sharp tip from poking through the sides or back end of the marshmallow 103 to stab the hand of the user. Even further, the coaxial multi-component roastable food item 110 can be fabricated as shown in FIG. 8 so that it adds to the convenience of roasting it on a pointed roaster such as the sharp stick 125. The coatable portion 107 of the core 101 is shorter than the soft outer layer (e.g., marshmallow 103) so that when the roasting stick (e.g., stick 125) is pushed into the bore hole 108 it pierces the soft outer layer 103 which will provide friction to help hold the roastable food item (s'more 110) on the stick 125 during roasting.

FIG. 11 illustrates an example of how a quantity of inside-out s'mores 110 can be conveniently packaged for sale in a vacuum formed plastic tray 130. Also shown are tray posts 131 which can protrude above the top level of the graham cracker cores 101 and thus protect the inside-out s'mores 110 while they are contained in, for example, a retail card board box.

FIGS. 12-19 show a few of the many potential variants of the inventive coaxial multi-component roastable food item 110, illustrated with the exemplary inside-out s'more 110 combination of food components. The cross-sectional views show internal details involving exemplary changes of the shape and relative sizes of components.

FIG. 12 shows the core 101 wherein the bore hole 108 has a top portion 109 that is a straight-sided (cylindrical) extension of a tapered portion. The top bore portion 109, which can alternatively be tapered as well, can aid in the manufacture of the graham cracker core 101, and also offers another method to grasp and support the inside-out s'more 110 because it causes the bore hole 108 to pass all the way through the core 101, thereby providing an opening at both axial ends of the inside-out s'more 110.

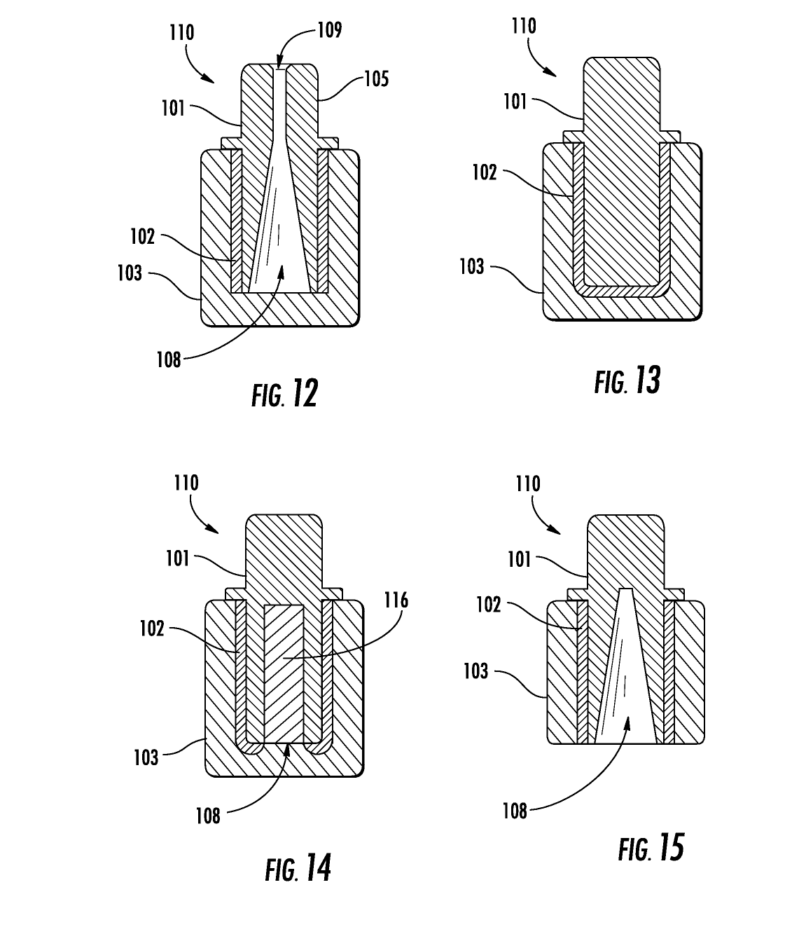

FIG. 13 shows a solid core 101.

FIG. 14 shows the core 101 with a cylindrical bore hole 108 and a food component used as a filling 116 in the bore hole 108, for an enhancement of the confection. For example, a tasty addition to the graham cracker, chocolate and marshmallow of a s'more might be a peanut butter filling 116. Of course, the filling 116 could be put into any sort of hollowed out cavity within the core 101; the cavity would not need to be axially aligned or bored or cylindrical.

FIG. 15 shows the coatable portion 107 of the core 101 extending through the outermost layer (e.g., marshmallow layer 103) such that a tapered bore hole 108 opens outward. This would allow a roaster tip to be press fit in the bore hole 108 without being sullied by melted coating layers (e.g., marshmallow layer 103).

FIG. 16 shows the core 101 with a shoulder portion 106 and with a bore hole 108 passing all the way through the core 101, but without a holding peg 105. In this example both of the first layer (e.g., chocolate 102) and the second layer (e.g., marshmallow 103) have partly backfilled the bore hole 108. This illustrates what may result from dipping the core 101 into liquefied or otherwise flowing food components for both of the first and second layers 102, 103. Or, for example, the second layer 103, e.g., marshmallow material could have been foamed on, or molded around it, etc. Many layer coating (laminating) processes are possible, limited only by the characteristics of the food components and the imagination of the confectioner given the teachings of this disclosure concerning its novel food item 110 structure and assembly.

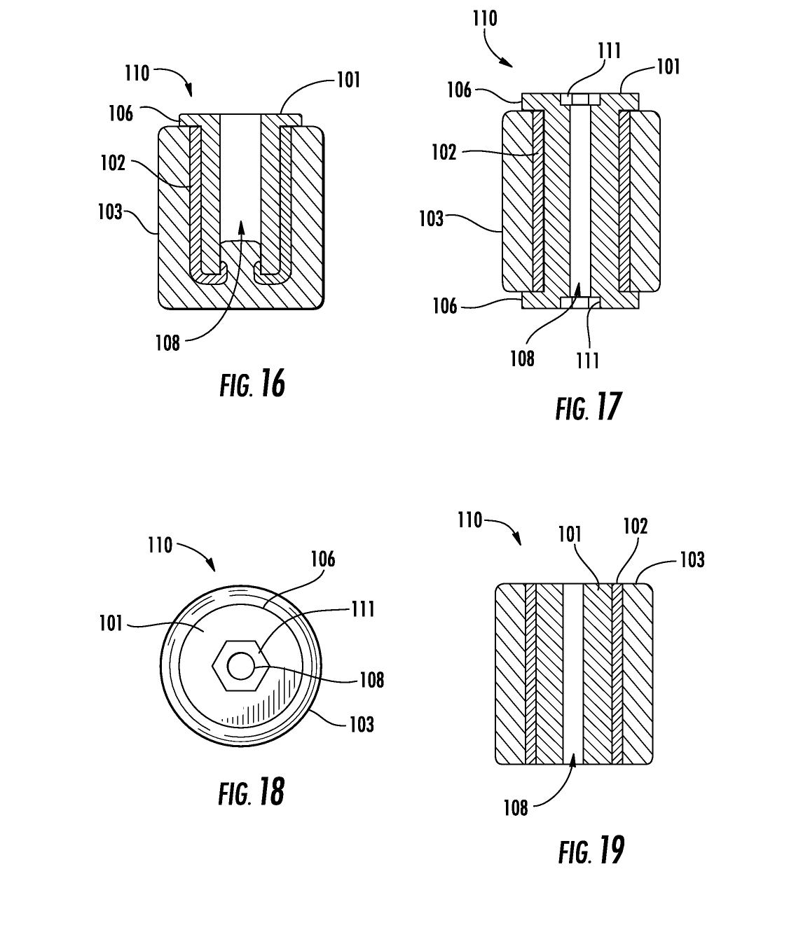

FIG. 17 shows the coaxial multi-component roastable food item 110 wherein the core 101 has a substantially cylindrical bore hole 108 passing all the way through. There isn't any holding peg portion 105, but a shoulder portion 106 is at both top and bottom ends of the core 101. A hexagonal counter bore 111 is at both ends of the bore hole 108, best seen in the top view of FIG. 18. These counter bores 111, which can be on one or both shoulders 106, can have any non-circular shape in order to provide anti-rotational keying when used with correspondingly mating roaster tips (e.g., internally gripping tip 129 described hereinbelow).

FIG. 19 shows the core 101 with a cylindrical bore hole 108, no holding peg portion (e.g., 105), and no shoulder portions (e.g., 106). This simplified form of the inventive food item 110 would probably be easy to make, even with a core 101 food component that might be difficult to shape (in which case the bore hole 108 might be eliminated as well).

FIGS. 20-25 illustrate another embodiment of a coaxial multi-component roastable food item 110 (e.g., an inside-out s'more) that is designed to be removably engaged with a roaster 120 that has an internally gripping tip 129. It should be noted that both this internally gripping tip 129 and the previously described cage style externally gripping tip 121 are other inventions by the present inventor.

FIGS. 20 and 21 show the inventive food item 110 wherein a core 101 has a holding peg portion 105 and a shoulder portion 106 that protrude out of a coaxially coated food layer 103. The holding peg portion 105 has a bore hole (top portion 109 visible) and a hexagonal counter bore 111.

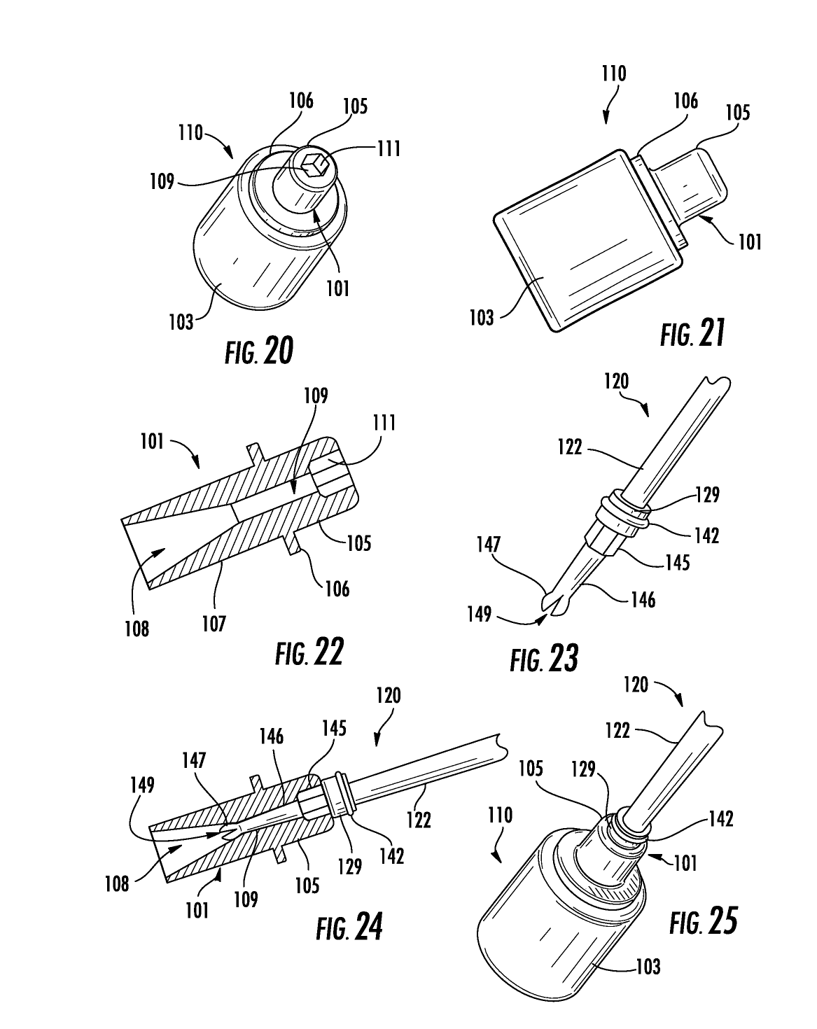

FIG. 22 is a cross-sectional side view of the core 101 for the subject food item 110. The core 101 has a holding peg portion 105, a shoulder portion 106, and a coatable portion 107. The bore hole 108 is fabricated with an inside wall shape that is approximately cylindrical at the top end 109 and then rapidly tapers outward at the other end. The hexagonal counter bore 111 provides a wider inside diameter at the end of the top bore portion 109. Preferably both the hexagonal counter bore 111 and the top bore portion 109 are slightly tapered upward (wider open at their top ends). Of course all references to a “bore” or “bore hole” or “bored portion” and the like should be broadly interpreted to include any suitable means for obtaining the desired cross section (inside wall shape). Obviously, besides drilling, the “bore” could be molded at the same time as the entire core 101, for example.

FIG. 23 shows an inventive internally gripping tip 129 on a rod member 122 to form a roaster 120 that is particularly adapted to work in conjunction with the core 101 that has bore holes 108, 109, and 111 as shown in FIG. 22. The internally gripping tip 129 is made of a resilient, heat resistant material, e.g. silicone, preferably having a durometer range of approximately Shore A 30-90, and FDA certification for food contact service. It may be clamped on the end of the roaster's rod member 122 by a ring clip 142, for example. The internally gripping tip 129 includes the following: a tapered hub 145 with a hexagonal cross-section, a tapered shank 146 with a round cross-section, and a domed tip 147 with a relief split 149 to make it compressible.

Both the shoulder 145 and the shank 146 portions of the tip 129 are tapered to match their mating portions of the core 101: the hexagonal counter bore 111 and the top bore portion 109, respectively. These tapered sections allow for easy insertion and removal of the internally gripping tip 129 in/out of the core 101.

FIG. 24 shows the internally gripping tip 129 of FIG. 23 removably engaged within the mating core 101 of FIG. 22 (viewed in cross-section). FIG. 25 shows the same in a perspective view of a complete inside-out s'more 110 embodiment of the inventive coaxial multi-component roastable food item 110 that is ready to be conveniently and safely roasted then eaten without further fuss and muss. After roasting, the s'more 110 can be safely eaten on the soft-tipped roaster 120, or it can be grasped by the holding peg 105, pulled off the roaster 120, and eaten while hand held. The shoulder portion 106 serves as a shield between the fingers and the gooey marshmallow layer 103 and softened chocolate layer 102 within (not shown in this view).

The internally gripping tip 129 is grippingly, but removably, engaged with the core 101 by pushing the gripping tip 129 in through the top end bores 111, 109 until fully seated in the core 101. When seated, the domed tip 147 projects beyond the intersection of the top bore portion 109 and the rapidly tapered bore hole 108 to “lock” the core 101 onto the gripper tip 129. Because the top bore portion 109 is gradually tapered, the intersection plane of the bottom and top bore hole portions 108 and 109 will be a restricting ring having the smallest internal diameter. When in the free or uncompressed state, the domed tip 147 has a slightly larger outside diameter than the bore hole 108 at the intersection plane. In order for the domed tip 147 to pass through the bore intersection plane 108/109 its dome shape must compress. Although the gripper tip 129 is a resilient material, the relief split 149 helps further to lower the force required to compress the domed tip 147 sufficiently. For added help, there can be crossed relief splits 149, or the dome shape may be flattened on either side of the relief split 149 to provide side clearance. Thus the force required to install a core 101 to, and remove it from, an internally gripping tip 129 is determined by: minimum inside diameter at the bore intersection plane 108/109, domed tip 147 uncompressed outside diameter and surface finish, material properties of the internally gripping tip 129, size and geometry of the relief split(s) 149, material properties of the core 101, bore surface finishes, and taper angles of the bores 108, 109, 111—especially the latter two bores.

When pushed into the core 101, the domed tip 147 is “funneled” in by the taper of the top bore 109, which also gradually compresses the domed tip 147 until it passes through the bore intersection restriction 108/109, after which it can expand back outwards again. The counter bore 111 engages with the hub 145, funneling it in until the hub 145 is stopped at the bottom of the counter bore 111. The positive stop prevents a user from wedging the internally gripping tip 129 too far into the core 101 whereupon it could split open the core 101. The mating hexagonal cross-sections prevent the food item 110 from rotating about the roaster tip 129.

The internally gripping tip 129 and mating core 101 as just described are merely one representative example of the inventive overall concept of removably holding a coaxial multi-component roastable food item 110 by press fitting a roaster holding tip (e.g., internally gripping tip 129) into a mating cavity (e.g., bore hole 108) formed within the structural core 101 of the food item 110. As long as the resilient tip 129 is laterally (e.g., diametrically) compressible and sized slightly bigger and/or differently shaped than the inside size and/or wall shape of the bore hole 108, 109, it will be held within the bore hole 108, 109 by friction. The other details are optional features that may improve the basic functionality of the tip 129. For example, the hub 145 and counter bore 111 could be round or left out entirely, relying on friction to prevent rotation. For example, some or even all of the bores 108, 109, 111 and/or the tip's hub and shank portions 145, 146 could be straight sided instead of tapered—again relying on friction alone. Many other variations will be apparent to the person of ordinary skill in the relevant art, and all should be considered within the scope of the present invention. In fact, even the sharpened stick 125 used as a roaster has a crude form of internally gripping tip 129 in that it is conical and can be wedged into the bore hole 108 for a friction fit.

Similarly, given the teachings of the present disclosure, many design and material variations for the coaxial multi-component roastable food item 110 will become apparent, all of which should be considered within the scope of the present invention. As an indication of how versatile the invention is, several variations are now presented. They include, but are not limited to any of the following examples:

Different combinations are included of core shape 101 and structural features (e.g., portions 105, 106, 107, 108, 109, 111), some of which were described with reference to FIGS. 6, and 12-22. For example, the shoulder portion 106 can be any diameter and placed anywhere along the axial length of the core 101, not just at the end(s) of the coatable portion 107. For example, there could be several shoulder portions 106 axially spaced along the coatable portion 107 and being only slightly larger in diameter than the coatable portion 107 to make a series of ridges that would be covered by one or more of the food layers 102, 103.

The cross-sectional shapes of the core 101, the first layer 102 and/or the second layer 103 don't necessarily have to be circular. They can be rectangular, triangular, square, pentagonal, hexagonal, oval, ribbed, spiral, irregular, etc.

A “graham cracker” core 101 can be made from a standard graham cracker recipe or can be flavored, e.g. chocolate, vanilla, etc.

An edible additive can be added to the recipe of the food component of the core 101 (e.g., graham cracker) to make it stronger.

A stiffening structure made of an edible material, e.g. sugar, starch, etc. can be incorporated into the food component of the core 101 (e.g., graham cracker) to make it stronger.

The hollow bore hole 108 (or 109, 111) of the core 101 can be used as a cavity that is filled with an edible filling 116 as shown, for example, in FIG. 14. For example, peanut butter, marshmallow, jelly, dried fruit, whipped chocolate, caramel, and the like might be good in combination with a graham cracker core 101.

The cavity for the filling 116 can be irregularly shaped and doesn't have to be axially aligned.

A marshmallow layer 103 can be flavored, e.g. cherry, grape, chocolate, and/or have an edible outer coating or shell, e.g. sugar, salt, candy sprinkles, etc.

Chocolate used for a layer 102 can be milk, dark, and/or white chocolate and/or can contain edible bits of food, e.g. nut pieces, puffed rice pieces, dried fruit pieces, etc.

The core 101 can be made of something edible other than graham cracker, as long as it is substantially rigid for providing the structural support for the inventive food item 110. Examples might include: cookie, pretzel, dried bread/crouton/biscotti, potato, etc.; however food items such as bread would likely need to be processed in a way that made them sufficiently strong to function as the supporting structure.

The first layer 102 can be made of something edible other than chocolate, e.g. yogurt, cheese, butter, egg, meat, dough, etc.

The second layer 103 can be made of something edible other than marshmallow, e.g. meat, fish, vegetable, dough, potato, etc.

In addition to the bore fillings 116 mentioned above, non-s'more fillings 116 could be, for example, catsup, mustard, relish, cheese, egg, etc.

The present invention will help to make the time honored camping or barbecuing tradition of dessert s'mores an easier, cleaner, safer, and quite possibly a less costly endeavor. In addition it opens up many exciting new possibilities for multi-component roastable food items.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention as claimed are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A coaxial multi-component roastable food item, wherein the term “roastable” refers to an item that is beneficially affected by exposure to a heat source, and/or that has a structure that facilitates roasting of the item, the food item comprising:
a structural core having a center axis and a coatable portion; and
one or more food layers that are coaxially coated about the coatable portion of the core;
wherein:
the core comprises a first food component that is formed into a shape having a central axis, and is processed such that it is sufficiently stiff and strong to be a structure for supporting all food components that are to be assembled with it; and
at least one of the one or more food layers comprises a second food component, different than the first food component.

2. The food item of claim 1, further comprising:
a first food layer that is coaxially coated about the coatable portion of the core; and
a second food layer that is coaxially coated about the first food layer; wherein:
the first food layer comprises a second food component, different than the first food component; and
the second food layer comprises a third food component, different from the first and second food components.

3. The food item of claim 2, wherein:
the core comprises graham cracker;
the first layer comprises chocolate; and
the second layer comprises marshmallow;
thereby forming an inside-out “s'more”.

4. The food item of claim 1, wherein:
an outwardly exposed one of the one or more food layers is roastable.

5. The food item of claim 1, wherein:
the core is substantially rotationally symmetric about the center axis;
the one or more food layers are only coated about the coatable portion of the core, and the coatable portion is less than an axial length of the core; and
an uncoated portion of the core comprises a holding feature that can be removably engaged with a holding tip of a roaster, thereby facilitating roasting of the food item.

6. The food item of claim 5, further comprising:
the uncoated portion of the core being formed into a relatively short, generally cylindrical holding peg shape designed to removably engage with a mating externally gripping roaster tip.

7. The food item of claim 1, further comprising:
a substantially axial bore hole that hollows out at least a portion of an axial length of the core and opens out through an axial end of the core.

8. The food item of claim 7, further comprising:
a filling comprising a filling food component, different than the first food component of the core, assembled as a filling in the bore hole; and wherein
a food layer extends over, and covers, the axial end of the core through which the bore hole opens.

9. The food item of claim 7, wherein:
the bore hole is fabricated with an inside wall shape and size designed to removably engage, by press fitting, with a mating elongated internally gripping roaster tip that is laterally compressible, and that has an uncompressed size slightly bigger and/or differently shaped than the bore hole's inside size and/or wall shape;
thereby facilitating roasting of the food item.

10. The food item of claim 9, wherein:
the bore hole funnels to a minimum diameter, then opens back up thereafter, thereby facilitating removable engagement with a roaster tip that has a domed tip with a relief split therein and a dome uncompressed diameter slightly greater than the bore hole minimum diameter.

11. The food item of claim 1, further comprising:
a flange-like shoulder portion of the core located at an axial end of the coatable portion of the core, and having a lateral dimension greater than that of the coatable portion.

12. A method of fabricating a multi-component food item such that it is roastable, the method comprising the steps of:
using a first food component to fabricate a substantially rigid support structure as a core;
forming the core in a substantially rotationally symmetric shape about a center axis; and
using a different food component for coaxially coating one or more food layers on a coatable portion of the core.

13. The method of claim 12, further comprising the step of:
using a roastable food component for an outwardly exposed one of the one or more food layers.

14. The method of claim 12, further comprising the steps of:
coating the one or more food layers only about the coatable portion of the core; and
leaving an uncoated portion of the core exposed for use as a holding feature that can be removably engaged with a holding tip of a roaster.

15. The method of claim 14, further comprising the step of:
forming the uncoated portion of the core into a relatively short, generally cylindrical holding peg shape designed to removably engage with a mating externally gripping roaster tip.

16. The method of claim 12, further comprising the step of:
forming a substantially axial bore hole that hollows out at least a portion of an axial length of the core and opens out through an axial end of the core.

17. The method of claim 16, further comprising the step of:
covering the bore hole opening by extending a coaxially coated food layer over an axial end of the core.

18. The method of claim 16, further comprising the step of:
fabricating the bore hole with an inside wall shape and size designed to removably engage, by press fitting, with a mating elongated internally gripping roaster tip that is laterally compressible, and that has an uncompressed size slightly bigger and/or differently shaped than the bore hole's inside size and/or wall shape.

19. The method of claim 18, further comprising the step of:
fabricating the bore hole with an inside wall shape that funnels to a minimum diameter then opens back up thereafter; and
providing a roaster tip that has a domed tip with a relief split therein and a dome uncompressed diameter slightly greater than the bore hole minimum diameter.

20. The method of claim 12, further comprising the step of:
fabricating a flange-like shoulder portion of the core located at an axial end of the coatable portion of the core, and having a lateral dimension greater than that of the coatable portion.
